(19) United States
(12) Patent Application Publication
(10) Pub. No.: US 2014/0103177 A1
(43) Pub. Date: Apr. 17, 2014

(54) HANGING BRACKET

(71) Applicant: Eagle FAN, Chu-Pei City (TW)

(72) Inventor: Eagle FAN, Chu-Pei City (TW)

(21) Appl. No.: 13/650,769

(22) Filed: Oct. 12, 2012

(51) Int. Cl. F16M 13/02

(52) U.S. Cl. 248/222.41

(57) ABSTRACT

A hanging bracket is provided, including a first element, a second element and at least a stop element. The first element and the second element have a plate shape, and are coupled on one side. The two elements can open up to 90°. The first element includes a hanging hole. The stop element is coupled to the first element, located close to the coupling position between the first element and the second element. After flipping, the stop element can protrude from the surface of the first element. As such, the hanging bracket can provide multiple function, including supporting portable electronic device when placing on desk top, temporary placement for portable electronic device during recharging, and storage for recharging wire.

### FIELD OF THE INVENTION

The present invention generally relates to a hanging bracket, and more specifically to a hanging bracket able to hang or place on desk top surface, as well small in size for convenient storage and portability.

### BACKGROUND OF THE INVENTION

Portable electronic devices, such as, mobile phone, personal video player, and so on, require recharging from time to time. There are two ways to recharge: the first is to connect to PC through USB connector, and the second is to plug the recharger to the wall electricity socket. When the recharger is plug into the wall electricity socket, the wire on the recharger will then connect to the portable electronic device. The common scenario is that the portable electronic device is lying on the floor close to the wall socket with wires scattering around the portable electronic device. The situation may easily cause scratches or sever damages to the portable device, but also may cause people to trip over the scattering wires. Some other users may use extension power cord so that the recharging electronic device can be placed on a desk top surface or on a seat of a chair. Neither is a satisfactory solution.

It is therefore desirable to devise a bracket for addressing the above problems encountered when recharging portable electronic device. In addition, the wire of the recharger can also be neatly stored to convenient portability or storage.

### SUMMARY OF THE INVENTION

The primary object of the present invention is to provide hanging bracket, for serving as a temporary placement of the portable electronic device during recharging to reduce the potential accidental damage. In addition, the present invention uses foldable structure to enhance convenience of storage and portability.

Another object of the present invention is to provide a bracket, for supporting portable electronic device when the portable electronic device is placed on desk top surface. As such, the bracket can also provide supporting function even not during recharging.

Yet another object of the present invention is to provide a bracket, for storing recharging wire connecting recharger and the portable electronic device. When not during recharging, the wire can be neatly stored in the bracket.

To achieve the above objects, the present invention provides a hanging bracket, including a first element, a second element and at least a stop element. The first element is a plate in a frame shape and includes a hanging hole. The first element and the second element are coupled on one side, and the two elements can open up to 90°. The stop element is coupled to the first element, located close to the coupling position between the first element and the second element. After flipping, the stop element can protrude from the surface of the first element.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the present invention in folded state;

FIG. 2 shows a schematic view of the present invention in expanded state;

FIG. 3 shows a side view of the present invention in folded state;

FIG. 4 shows a schematic view of the hanging bracket of the present invention used for supporting a portable electronic device placed on desk top;

FIG. 5 shows a schematic view of the hanging bracket of the present invention used for temporary placement for a portable electronic device during recharging; and

FIG. 6 shows a schematic view of the hanging bracket of the present invention used for storing wire.

### DETAILED DESCRIPTION OF THE PREFERRED EMBODIMENTS

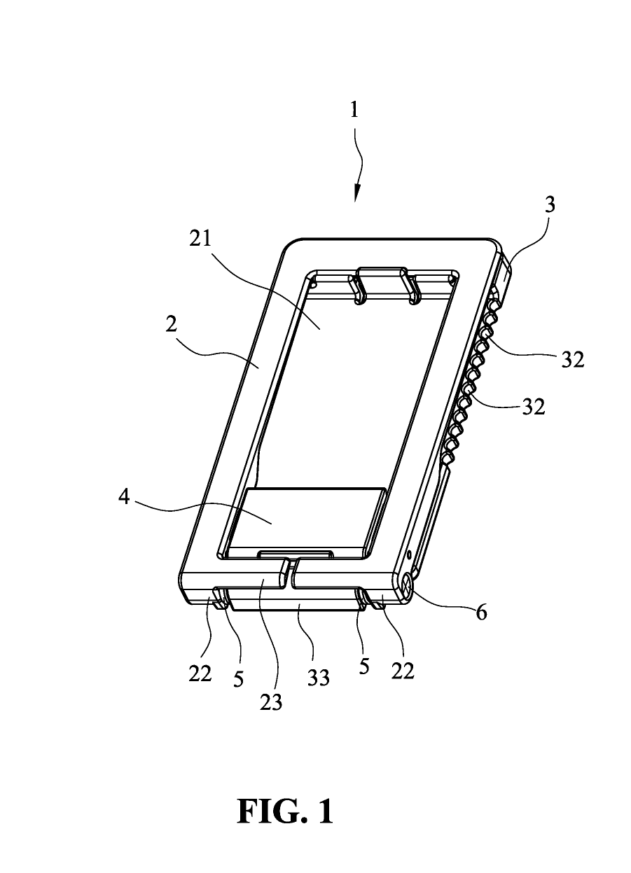

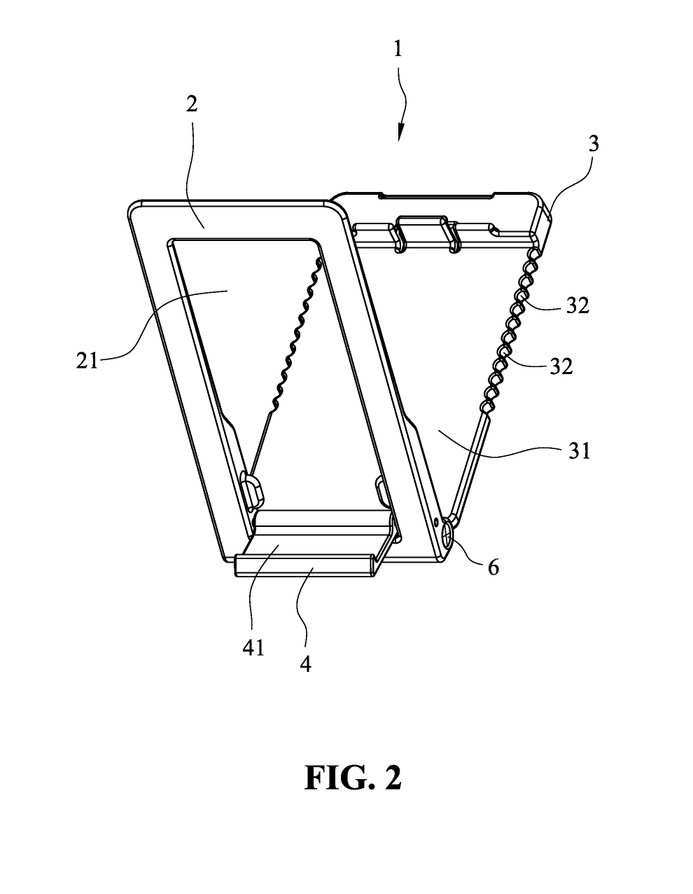

FIG. 1 and FIG. 2 show schematic views of the present invention in a folded state and an expanded state respectively. A hanging bracket 1 of the present invention includes a first element 2, a second element 3, and at least a stop element 4. First element 2 and second element 3 are both of plate shape, with one side coupled together. When not in use, hanging bracket 1 is folded to reduce the size for easy storage. When first element 2 and second element 3 are expanded to form an angle, hanging bracket can provide two functions: 1. providing temporary placement for portable electronic device during recharging; and 2. providing support to portable electronic device when placed on a top surface of a desk. In addition, the hanging bracket of the present invention can also be used as a storage place for recharging wire when the recharging wire is not in use.

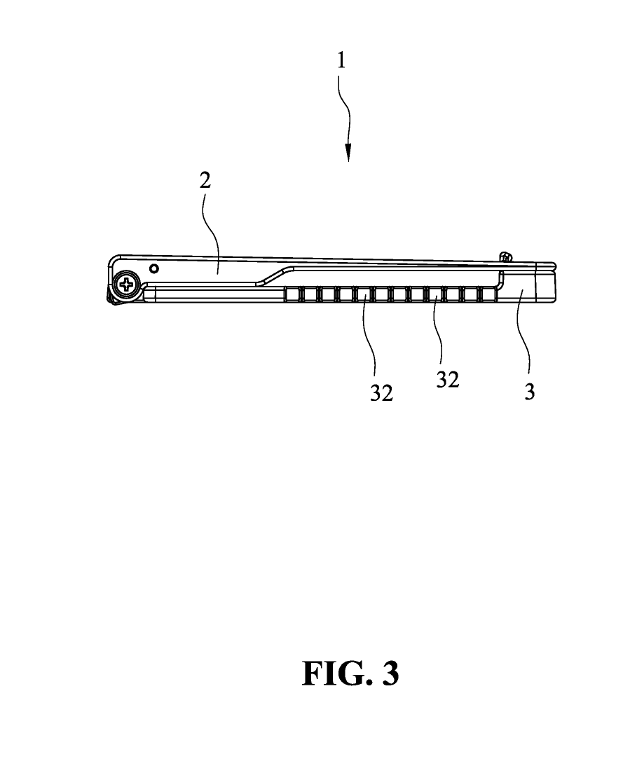

The following describes the structure of the present invention. First element 2 is a plate in a frame shape, with a hanging hole 21 at center area. The size of hanging hole 21 allows the plug to pass through. The thinnest segment is less than 3 mm. The segment is away from the coupling position between first element 2 and second element 3. First element 2 and second element 3 are coupled on one side, and can be folded together when not in use to form a rectangle, as shown in FIG. 1 and FIG. 3. To use, flip first element 2 open with coupling position as center so that an angle up to 90° can be formed between first element 2 and third element 3. In the present embodiment, the maximum angle between first element 2 and third element 3 is less than 90°. Second element 3 is a rectangular plate, with thickness thicker than first element 2. Second element 3 is disposed with a concave placement surface 31 at the center area, for placing portable electronic device during recharging. Placement surface 31 is facing first element 2. Two sides of second element 3 on both sides of placement surface 31 are disposed with a plurality of wire trenches 32. Wire trench 32 is concave arc-shaped for providing guiding and fixing a wire when the wire is wound around the outer circumference of second element 3.

Because hanging bracket 1 of the present invention cal also provide support for portable electronic device when placing on desk top, first element 2 and second element 3 must be able to maintain an angle when an applied force flipping open vanishes. Hence, in the present embodiment, the coupling position between first element 2 and second element 3 must be appropriately tight while staying rotatable. In addition, the hanging bracket must be able to retighten again after an extended period of usage to extend the life span of hanging bracket 1. Therefore, at least a buffer pad 5 and at least a screw 6 are disposed at the coupling position between first element 2 and second element 3. Buffer pad 5 is made of rubber, and is disposed at the center of the contact surfaces between first element 2 and second element 3. Two screws 6 are used and each screw 6 penetrates first element 2 at coupling end 22 and buffer pad 5, and fastened to second element 3 at coupling end 33. The coupling side 23 of first element 2 is not closed. During assembly, screw 6 can be adjusted to adjust the tightness of the coupling position. When the coupling position is loose after extended period of time, because coupling side 23 of first element 2 is not closed and buffer pad 5 is made of soft material, screw 6 can be tightened again to maintain the appropriate tightness of the coupling position. Stop element 4 is coupled to first element 2, located close to coupling position between first element 2 and second element 3. In the present embodiment, stop element 4 is located in hanging hole 21. When flipped, stop element 4 can protrude above the surface of first element 2 facing second element 3. Stop element 4 includes a concave surface 41 for preventing an object placed on from sliding.

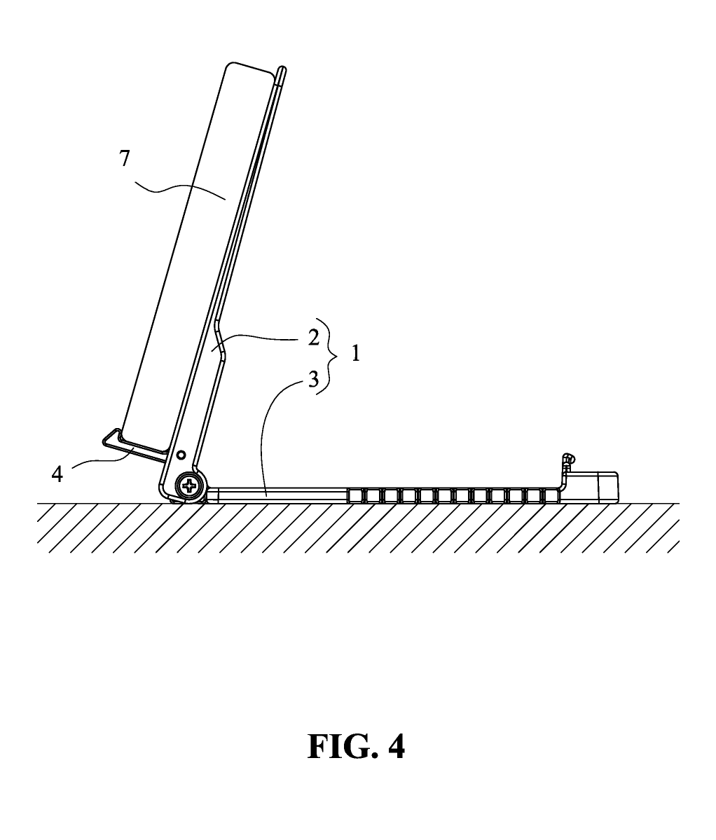

FIG. 4 shows a schematic view of the hanging bracket of the present invention used for supporting a portable electronic device 7 placed on desk top. As shown in FIG. 4, first element 2 is flipped upwards so that an acute angle is formed between first element 2 and second element 3. As described earlier, the angle and the position of the two elements will be fixed. Then, stop element 4 is flipped open to protruding above surface of first element 2. As such, hanging bracket 1 becomes a support device able to support an object. Portable electronic device 7, such as, mobile phone, can be placed on a side surface of first element 2 and stop element 4 contacts the lower edge of portable electronic device 7 so that portable electronic device 7 will not slide off. For adjusting the tilt angle of portable electronic device 7, the angle between first element 2 and second element 3 can be adjusted.

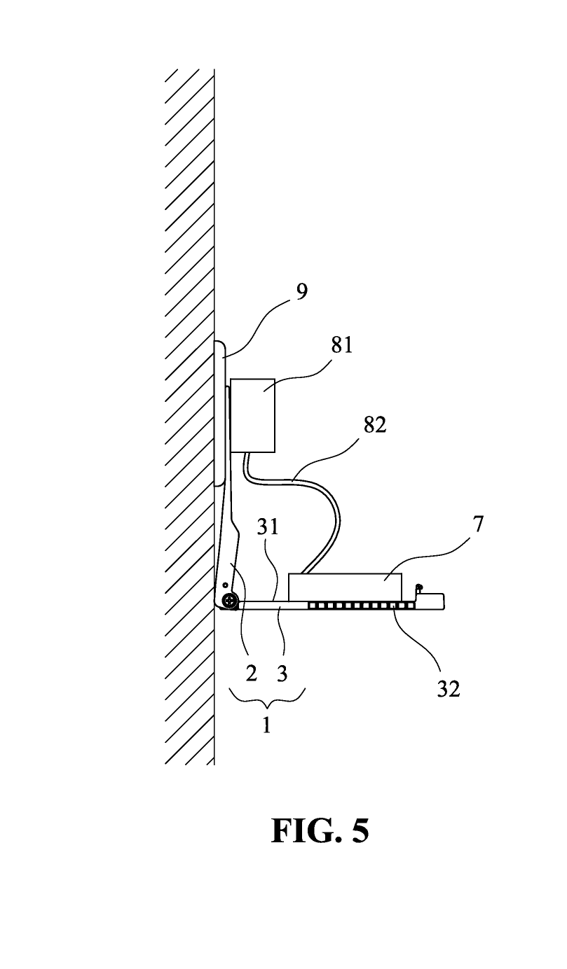

FIG. 5 shows a schematic view of the hanging bracket of the present invention used for temporary placement of a portable electronic device 7 during recharging. The two metal plates (not shown) of a plug 81 of a recharger are plugged into socket 9 on the wall. Flip open first element 2 and second element 3 to form maximum angle. Place hanging hole 21 of first element 2 over the outer circumference of plug 81 so that first element 2 hangs between plug 81 and socket 9. The metal plates of plug 81 support the weight of hanging bracket 1. Portable electronic device 7 is placed on placement surface 31, and wire 82 of recharger is connected to portable electronic device 7 and plug 81. A such, during recharging, portable electronic device 7 stays close to the wall on hanging bracket 1 to avoid being accidentally kicked. Because the part of first element 2 between plug 81 and socket 9 is less than 3 mm, first element 2 has no effect on the electrical connection between metal plates of plug 81 and socket 9.

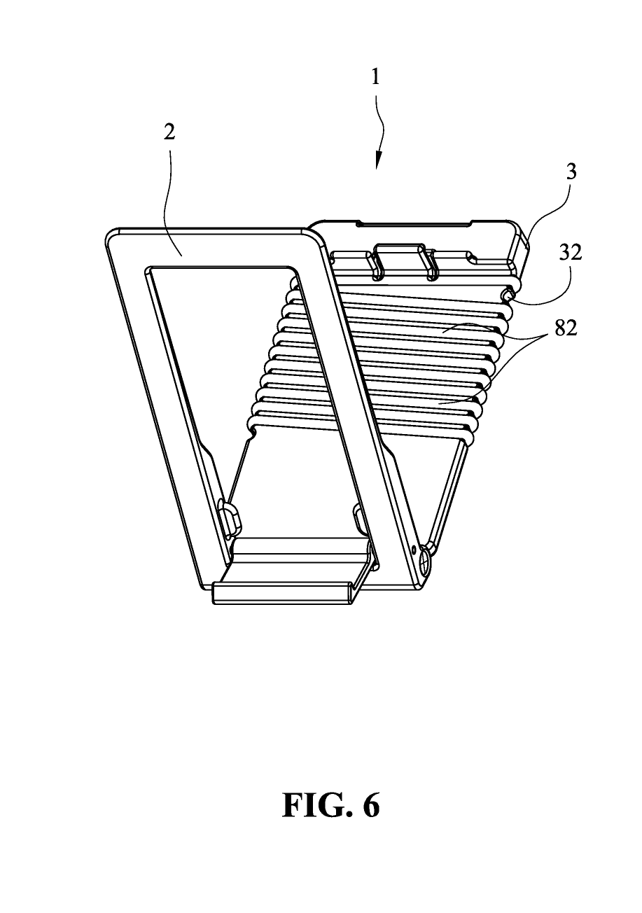

As shown in FIG. 6, when not recharging, wire 82 can be wound around outer circumference of second element 3. As such, wire 82 is partially located inside wire trench 32 so that wire 82 is easily stored. In addition, first element 2 is folded to second element 3 so that wire 32 can be clamped. Therefore, hanging bracket 1 is convenient for portability and wire 82 can be easily retrieved fro recharging.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A hanging bracket, comprising:
a first element;
a second element; and
at least a stop element;
wherein said first element being a plate in a frame shape and having a hanging hole;
said second element being a plate, coupled to said first element at a coupling position, said two elements able to open up to 90°; and
said stop element being coupled to said first element, located close to coupling position between said first element and said second element; after flipping, said stop element able to protrude from a surface of said first element facing said second element.

2. The hanging bracket as claimed in claim 1, wherein said coupling position between said first element and said second element is tight but remains rotatable, and when an external force is applied to adjust an angle between the two elements, the two elements can maintain the adjusted angle even after the external force vanishes.

3. The hanging bracket as claimed in claim 2, wherein a buffer pad and at least a screw are disposed at said coupling position between said first element and said second element, said buffer pad is disposed at center of contact surfaces between said first element and said second element, and each screw penetrates said first element at coupling end and said buffer pad, and is fastened to said second element at coupling end, coupling side of coupling position between said first element and said second element is not closed.

4. The hanging bracket as claimed in claim 1, wherein said second element is thicker than said first element, and has a concave placement surface at center area, said placement surface of said second element faces said first element.

5. The hanging bracket as claimed in claim 1, wherein said hanging hole allows a recharger to pass through.

6. The hanging bracket as claimed in claim 1, wherein said first element comprises a thinnest segment with thickness less than 3 mm.

7. The hanging bracket as claimed in claim 1, wherein two opposite side walls of said second element comprises a plurality of wire trenches.
